(19) United States
(12) Patent Application Publication
(10) Pub. No.: US 2012/0031569 A1
(43) Pub. Date: Feb. 9, 2012

(54) SAFETY WINDOW SHADE ASSEMBLY

(75) Inventors: Leonard Elinson, Manhattan Beach, CA (US); Richard R. Fraczek, Valencia, CA (US)

(73) Assignee: MARIAK INDUSTRIES, INC., Rancho Dominguez, CA (US)

(21) Appl. No.: 12/958,182

(22) Filed: Dec. 1, 2010

Related U.S. Application Data
(60) Provisional application No. 61/372,033, filed on Aug. 9, 2010.

(51) Int. Cl. E06B 9/80; E06B 9/58

(52) U.S. Cl. 160/127; 160/178.2

(57) ABSTRACT

A dual shade apparatus comprises a first shade, which may be a Roman or natural woven shade, and a second shade, which may be a cellular shade, coupled to each other in a back-to-back arrangement with one or more dual channeled couplers. Any lift cords employed in the apparatus are concealed in between the pair of shades so as to prevent any direct contact. No portion of any employed cords is exposed or accessible for direct or inadvertent contact, thereby enhancing safety in operating the apparatus. The coupler has a double-C configuration to receive corresponding retaining mechanisms of the front and rear shades. A head rail houses a lifting mechanism. Each lifting cord extends from the lifting mechanism, in between the two shades, and down to a bottom rail. The dual shades are drawn down or retracted in unison by pulling or pushing up the bottom rail.

### RELATED APPLICATIONS

This application claims priority from U.S. Provisional Patent Application Ser. No. 61/372,033 filed on Aug. 9, 2010 and entitled WINDOW SAFETY SHADE CONSISTING OF ROMAN SHADE AND CELLULAR SHADE, the disclosure of which is incorporated herein by reference in its entirety.

### BACKGROUND OF THE INVENTION

1. Field of the Invention

The present invention relates to a shade or screen assembly for fenestrations, including windows and skylights.

2. Description of Prior Art and Related Information

Window shades in the prior art typically employ lift cords to enable a user to raise and lower the shades as desired. Conventional lift cords are usually exposed to physical since they are intended to be accessed by the user. However, such exposed cords have posed child hazards in the recent past as these cords can cause children to get trapped, and particularly choked.

Therefore, a need has arisen to provide window treatments, particularly those having shades, without exposing any cords.

### SUMMARY OF THE INVENTION

The present invention provides structures and methods which overcome the deficiencies in the prior art.

In one aspect, a safety window shade apparatus is provided. The apparatus comprises a first front shade and a second rear shade. The first shade has a first display side, a first inward side and a first retaining mechanism. The second shade is disposed adjacent to the first inward side of the first shade. The second shade comprises a second retaining mechanism. A dual channeled coupler couples the first shade to the second shade. The coupler comprises a first channel configured to receive the first retaining mechanism and a second channel configured to receive the second retaining mechanism. In the preferred apparatus, no portion of a cord is disposed anywhere other than in between the first fabric and the second fabric.

The first shade may comprise a Roman shade. The second shade may comprise a cellular shade. The first channel preferably comprises a first C-channel, and the second channel preferably comprises a second C-channel. The second retaining mechanism comprises a cylindrical shaft. The first shade may comprise separate segments, where the first retaining member comprises a pair of separate transverse rigid strips, each strip coupled to a corresponding segment.

The first shade may also comprise a natural woven shade. Where the first shade comprises a natural woven shade, the first retaining mechanism may comprise a shaft configured to be received in the first channel, and a ring coupled to the shaft and the natural woven shade.

The apparatus further comprises a head rail, and a cordless lifting mechanism housed in the head rail and configured to facilitate the lifting and lowering of the first and second fabrics. The apparatus further comprises a bottom rail coupled to a first bottom end of the first fabric and to a second bottom end of the second fabric. The apparatus further comprises a cord extending through one or more holes in the second shade and coupled to the bottom rail.

In another aspect, a safety window shade apparatus comprises a first front shade, a second rear shade, and a double-C coupler. The first front shade comprises a first display side, a first inward side, a first retaining mechanism and a first perimeter. The second rear shade is disposed adjacent to the first inward side of the first fabric. The second fabric comprises a second retaining mechanism and a second perimeter. The first perimeter and second perimeter are generally aligned to form a collective perimeter.

The double-C coupler comprises a first C-channel configured to receive the first retaining mechanism, and a second C-channel configured to receive the second retaining mechanism. A lifting cord is disposed entirely between the first fabric and the second fabric. Thus, the cord has no portions exposed beyond first perimeter or second perimeter.

The first shade may comprise a Roman shade. The second shade may comprise a cellular shade. If the first shade comprises separate segments, the first retaining mechanism may comprise a pair of separate transverse rigid strips, each strip coupled to a corresponding segment.

If the first shade comprises a natural woven shade, the first retaining mechanism may comprise a shaft configured to be received in the first channel, and a ring coupled to the shaft and the natural woven shade. The second retaining mechanism may comprise a shaft

The apparatus further comprises a head rail, and a cordless lifting mechanism housed in the head rail and configured to facilitate the lifting and lowering of the first and second fabrics. The apparatus may further comprises a bottom rail coupled to a first bottom end of the first fabric and to a second bottom end of the second fabric. The cord is coupled to the bottom rail.

In a further aspect, a method of manufacturing a window shade assembly is provided. The method comprises providing a first shade, providing a second shade, coupling the first shade to a dual open-sided coupler, coupling the second shade to the dual open-sided coupler, disposing a lift cord entirely in between the first and second shades, and preventing any portion of the lift cord from being exposed and accessible to physical contact.

The method further comprises housing a cordless lifting mechanism within a head rail, and coupling the first shade and the second shade to the head rail.

The step of coupling the first shade to the dual open-sided coupler comprises disposing in a first channel of the coupler a shaft coupled to the first shade. The step of coupling the first shade to the dual open-sided coupler comprises coupling a ring to the shaft and the first shade.

The step of providing the first shade comprises forming fabric segments, each segment having a top retaining strip and a bottom retaining strip. The step of coupling the first shade to the dual open-sided coupler comprises disposing a top retaining strip and a bottom retaining strip of adjacent segments into a first C-channel of the coupler.

The step of coupling the second shade to the dual open-sided coupler comprises disposing in a second channel of the coupler a shaft coupled to the second shade.

### BRIEF DESCRIPTION OF THE DRAWINGS

FIG. 1 is a perspective view of a first preferred embodiment of a window shade apparatus;

FIG. 2 is a close-up perspective view of the encircled area in FIG. 1;

FIG. 3 is a cutaway side view of a top portion of the first preferred shade apparatus, including a head rail assembly;

FIG. 4 is a side view of the first preferred shade apparatus;

FIG. 5 is a front perspective view of the first preferred shade apparatus as retracted;

FIG. 6 is a cutaway side view of the first preferred shade apparatus as retracted;

FIG. 7 is a perspective view of a second preferred embodiment of a window shade apparatus;

FIG. 8 is a perspective view of a third preferred embodiment of a window shade apparatus;

FIG. 9 is a diagram of a preferred method of making a cordless shade apparatus; and

FIG. 10 is a diagram of a cordless method of operating a dual shade apparatus.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

Throughout the specification, positional and directional terms below refer to the following:
axial or vertical generally refer to the direction in which the shade is drawn or retracted;
lateral, sideways or horizontal refer to a direction generally perpendicular to the direction in which the shade is drawn or retracted;
back and front refer to the perspective of a user located within the building and facing the apparatus.

While the preferred window shade apparatuses described herein may employ cords, these preferred embodiments may be described as “cordless” in the sense that none of the employed cords are exposed.

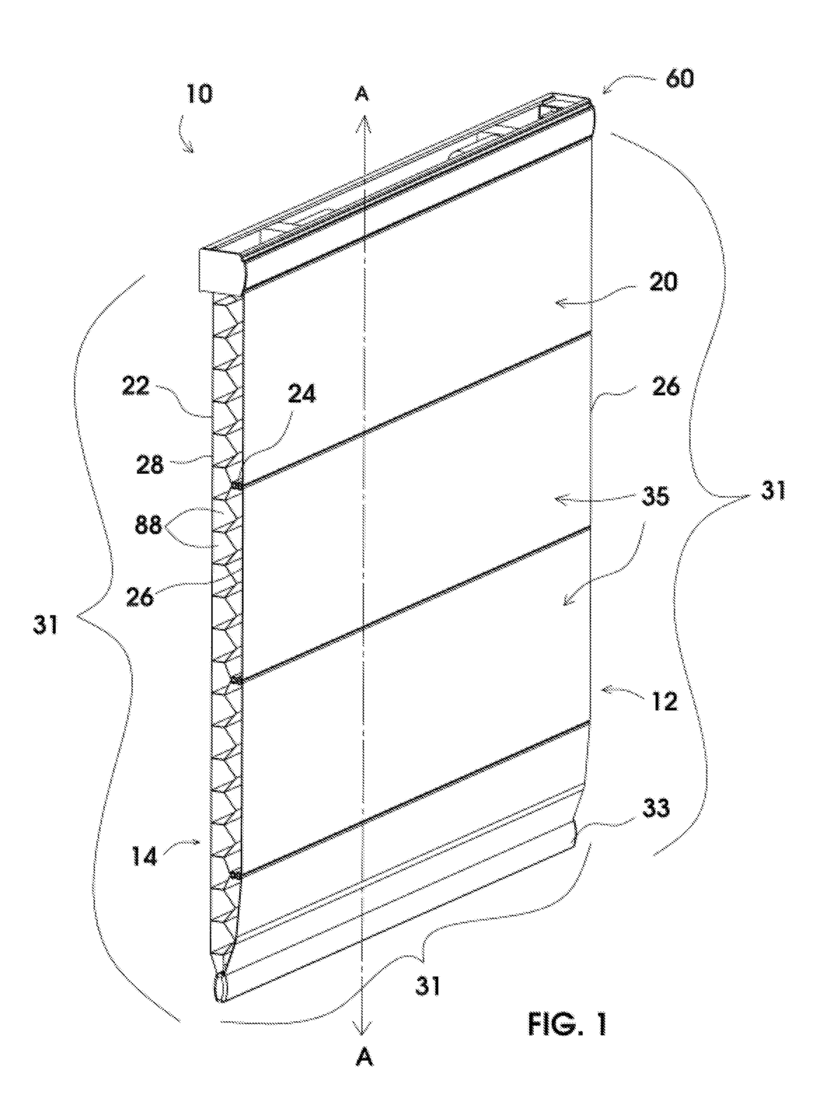

In FIG. 1, a first preferred embodiment of a safety window shade apparatus, or simply shade apparatus, is illustrated and designated generally by the reference numeral 10. The preferred shade apparatus 10 is configured to be used with any fenestration, such as windows and skylights, in any orientation (e.g., vertical, horizontal, etc.). The apparatus 10 defines an axis “A” generally parallel to the direction in which a shade is drawn. The apparatus 10 also includes a front side 12 facing a window and an exterior of the building in which the apparatus 10 is employed, and a back, or rear, side 14 facing an interior of the building.

The apparatus 10 comprises dual shades, namely, a first front shade 20 and a second rear shade 22. In the first preferred embodiment, the first shade 20 may comprise a Roman fabric shade while the second shade 22 may comprise a cellular shade. It is to be expressly understood that each of the dual shades may comprise any kind of shade material, which may or may not be composed of fabrics.

The dual shades 20, 22 are disposed in a back-to-back arrangement. Thus, the front shade 20 is disposed adjacent to an inward, or interior, side of the rear shade 22, and the rear shade 22 is disposed adjacent to an inward, or interior, side of the front shade 20. The dual shades 20, 22 are coupled to each other with a preferred coupler, or connector, 24 as described in further detail below. The first shade 20 includes a first pair of side edges 26 which are preferably aligned with a second pair of side edges 28 of the second shade 22. Accordingly, the apparatus 10 includes a collective shade perimeter 31 collectively defined by the aligned side edges 26, 28 and a bottom rail 33. In the preferred embodiment, no portion of any cords employed in the apparatus 10 extends or lies exposed beyond this shade perimeter 31.

It is within the scope of the invention to omit the bottom rail 33, in which case a bottom portion of the front shade 20 would be aligned and coupled to a bottom portion of the rear shade 22. In such an embodiment, the collective perimeter, which defines the boundaries in which any cords would be disposed, would be defined by the aligned pairs of side edges of the front and rear shades, and the coupled bottom portions.

As described in further detail below, the dual shades 20, 22 hang or extend from a head rail 60. In unison, the dual shades 20, 22 are thus drawn away from or retracted toward the head rail 60 along the axis A.

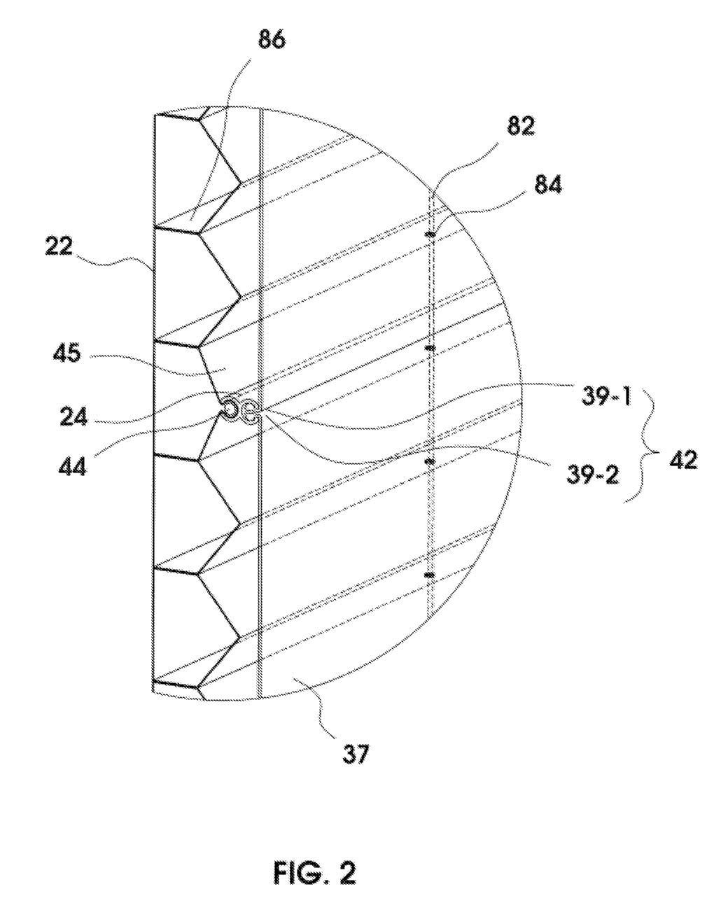

In the first preferred embodiment of the apparatus 10, the front shade 20 comprises separate segments 35. As shown more clearly in the close-up view of FIG. 2, each segment 35 includes a generally flat planar portion 37 and a pair of transverse retaining strips 39, namely, a bottom strip 39-1 of an upper segment and a top strip 39-2 of a lower segment located beneath the upper segment. Accordingly, the front shade 20 includes a first plurality of front retaining mechanisms 42, each front retaining mechanism 42 comprising a pair of adjacent strips, namely, the bottom strip 39-2 of an upper segment 37 and a top strip 39-1 of a lower, adjacent segment 37. Alternatively stated, the adjacent bottom strip 39-2 and top strip 39-1 of adjacent segments 37 collectively form each retaining mechanism 42.

The rear shade 22 includes a second plurality of rear retaining mechanisms 44, each rear retaining mechanism 44 preferably comprising a cylindrical shaft 44 which may be coupled to, formed integrally with, a front pleated section 45 of the cellular shade 22.

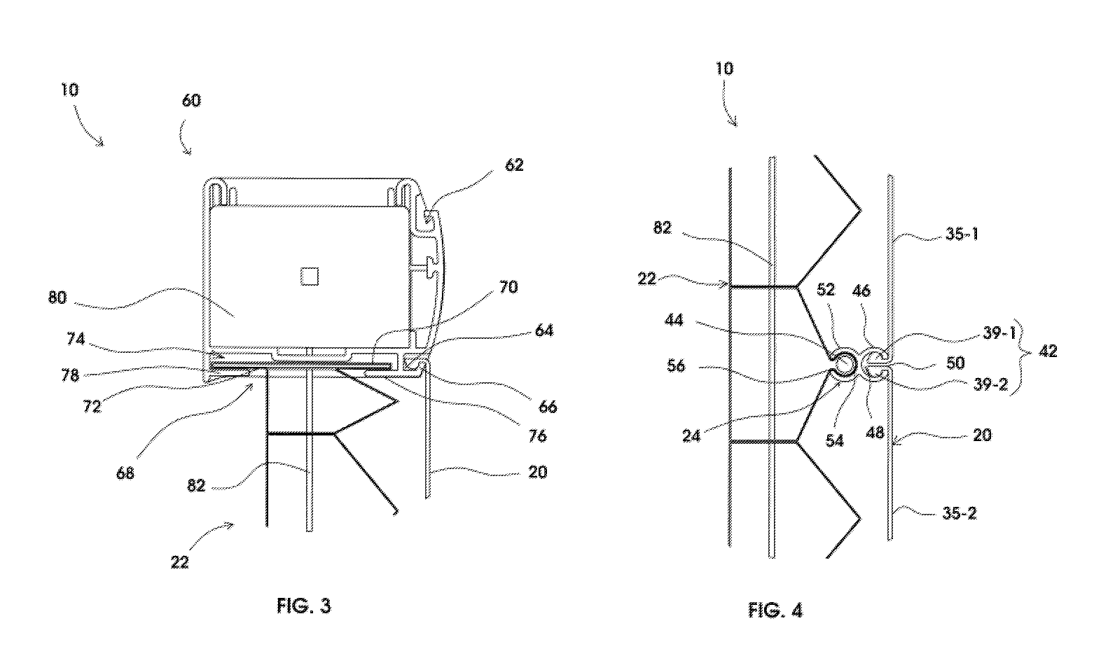

FIG. 3 illustrates a preferred head rail assembly, or simply head rail, 60. The head rail 60 comprises an upper transverse opening 62 configured for attaching valances, and a lower transverse opening 64 for receiving the front shade 20. The front shade 20 includes a top head rail connector 66 which may comprise a retaining strip or a shaft housed within a pocket of the shade material.

A top portion 68 of the rear shade 22 is coupled to the head rail 60. The top portion 68 may comprise an inner strip 70 and an outer strip 72, both composed of a stiffener material and housed within a rear chamber 74 of the head rail 60. A first, inner closure support 76 helps retain the inner strip 70 while a second, outer closure support 78 helps retain the outer strip 72.

Any one of a variety of lifting mechanisms may be employed and housed within the head rail 60. The lifting mechanism 80 preferably comprises a device that does not require the user to directly engage or contact any external cords in order to lower or retract the shades. Accordingly, the lifting mechanism 80 preferably comprises a “cordless lifting mechanism” which operates with constant force springs. The lifting mechanism 80 employs at least one lift cord 82 extending from the bottom of the mechanism 80 through a bottom opening in the head rail 60. As shown in FIG. 2, the cord 82 extends through openings 84 formed in the rear shade 22.

Referring back to FIGS. 1 and 2 where the rear shade 22 comprises a cellular shade in the preferred embodiment, the shade openings 84 are defined in horizontal planar sections 86 of the cellular shade 22. The apparatus 10 preferably employs two transversely spaced apart lift cords 82, each extending through the horizontally oriented openings 84 down to a bottom rail 33. The bottom rail 33 comprises space to hold any excess length of each cord 82. Accordingly, as illustrated in FIG. 1, no portion of any cords used in the apparatus 10 is exposed beyond the perimeter 31 of the dual shades 20, 22. Therefore, no portion of any employed cords 82 is accessible for regular or inadvertent contact since said cords 82 are preferably nestled within the confines of the head rail 60, the shades 20, 22, and the bottom rail 88. Thus, no portion of any employed cords 82 are exposed or protruding outwardly from the apparatus 10.

FIG. 4 illustrates a side view of a section of the first preferred apparatus 10 with the shades 20, 22 drawn down. From this side view, the shade coupler 24 preferably comprises a back-to-back double-C configuration, including a first C-shaped tube 46 defining a first front cylindrical channel 48 and a first front slot 50 opening thereto, and an oppositely facing second C-shaped tube 52 defining a second rear cylindrical channel 54 and a second rear slot 56 opening thereto. In the preferred embodiment, the dual channeled coupler 24 may be extruded and the transversely extending channels 48, 54 sized to receive the respective transversely extending retaining mechanisms 42, 44 securely.

The rear channel 54 receives the rear retaining mechanism 44 which may comprise a cylindrical shaft 44 coupled to the rear shade 22. In the preferred embodiment, the rear cylindrical shaft 44 is enclosed within a pocket of fabric formed in the front, pleated section 45 of the rear shade 22, the pocket of fabric also enclosed within the rear channel 54.

The front channel 48 of the coupler 24 receives the first retaining mechanism 42 of the front shade 20 which, in this preferred embodiment, comprises a pair of adjacent strips, namely, the bottom strip 39-1 of an upper segment 35-1 and a top strip 39-2 of a lower, adjacent segment 35-2.

It will be appreciated that the apparatus 10 may comprise multiple couplers 24 vertically spaced apart (i.e., along the axis of the shades 20, 22), such as with the illustrated embodiment in FIG. 1 which shows three couplers 24, for example. Accordingly, each shade 20, 22 comprises multiple retaining mechanisms 42, 44, respectively, where each front retaining mechanism 42 is preferably positioned adjacent to a corresponding rear retaining mechanism 44 so that each pair of mechanisms 42, 44 is aligned. This way, each pair of aligned front and rear retaining mechanisms 42, 44 may be connected to a corresponding dual channeled coupler 24, thereby preventing any wrinkles or undesired folds in the shades 20, 22 when drawn down. The coupler 24 thus maintains each pair of mechanisms 42, 44 in a fixed relationship whether the shades 20, 22 are drawn down or retracted.

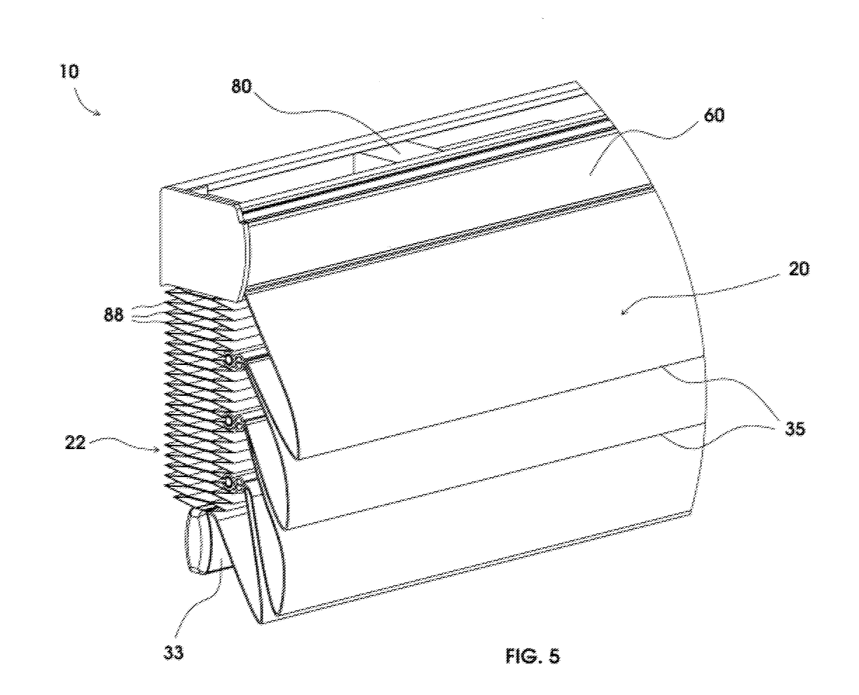

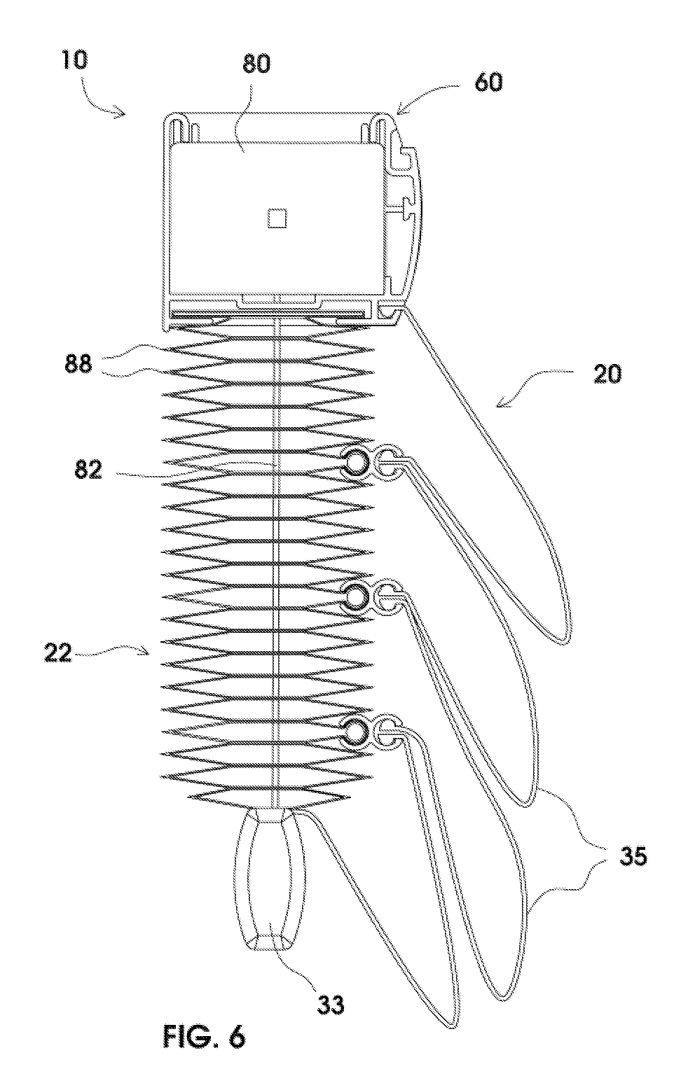

FIGS. 5 and 6 illustrate the first preferred apparatus 10 with the shades 20, 22 retracted. To operate the apparatus 10, a user has to push or pull on the bottom rail 33 along the axis (i.e., toward or away from head rail 60). Pushing up on the bottom rail 33 releases tension from the lifting cords and allows the cords (hidden in between shades 20, 22) to roll up on the lifting drum inside of the lifting mechanism 80. Once the bottom rail 33 moves up, the cells 88 of the cellular shade 22 will collapse into folded sections, and lift up together with Roman shade fabric 20 coupled thereto. Roman shade segments, or panels, 35, which appear planar when fully extended as shown in FIG. 1, will fold up during this process and create a droopy, hobbled look where the panels 35 overlap on top of each other. Even in the fully retracted position as illustrated, no portion of the employed cords are exposed or accessible for direct or inadvertent contact.

To lower the dual shades 20, 22 in unison, the bottom rail 33 is pulled. The bottom rail 33 coupled to the lifting cords 82 will pull the cords down and roll the cords out of the drum of the lifting mechanism 80. Cells 88 of the rear cellular shade 22 will open up and hobbles 35 of the front Roman shade 20 will stretch out until the whole shade duo 20, 22 fully extends, as shown in FIG. 1.

Therefore, the preferred embodiment of the apparatus 10 operates by enabling the user to draw or retract the shades 20, 22 without having to contact any cords, which are hidden from view and inaccessible anyways. Therefore, a cordless method of operating the apparatus 10 is provided whereby the user need only engage the bottom rail 33 to draw or retract the shades 20, 22.

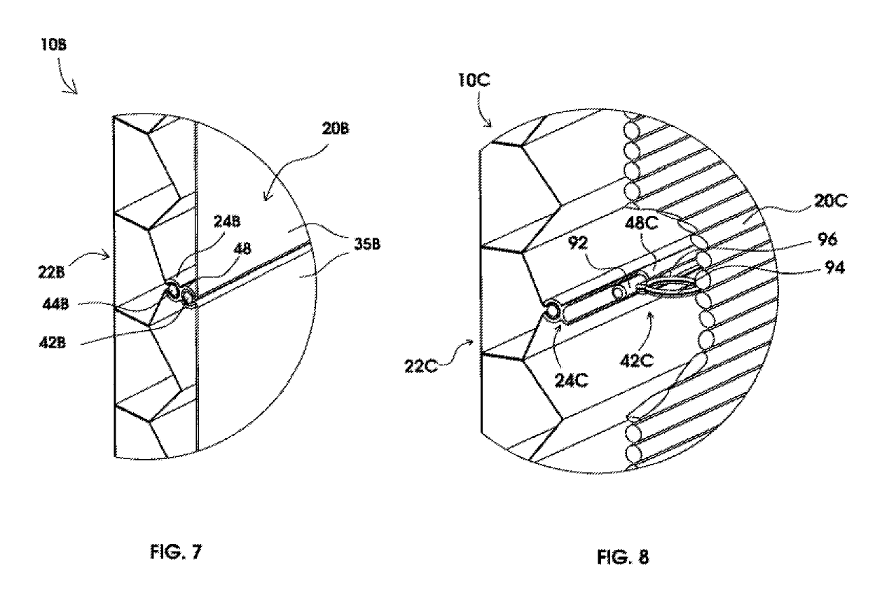

FIG. 7 illustrates a second preferred embodiment of the shade apparatus 10b where elements of similar structure and/or function are designated by the same reference numerals followed by the letter b. In the second preferred embodiment 10b, the front Roman shade 20b may comprise integral segments 35b, all of which may be formed from a single fabric material, as opposed to the separate segments 35 of the first preferred embodiment 10 shown in FIGS. 1-6. Each front retaining mechanism 42b may comprise a cylindrical shaft enclosed within a pocket of shade material, where the shaft 24b and surrounding pocket material are configured to fit snugly in the front channel 48 of the dual channeled coupler 24b. Therefore, the front retaining mechanism 42b in the second preferred embodiment may be substantially similar to the rear retaining mechanism 44b which also comprises a cylindrical shaft coupled to the rear cellular shade 22b comprising a cellular material.

FIG. 8 illustrates a third preferred embodiment of the shade apparatus 10c having a front shade 20c comprising a natural woven shade (NWS) 20c. The natural woven shade 20c may comprise bamboo, grass, wood, or other natural materials. In this third preferred embodiment, the front retaining mechanism 42c comprises a cylindrical shaft 92 configured to fit snugly in the front channel 48c of the dual channeled coupler 24c. The front retaining mechanism 42c further comprises a ring connector 94 that couples the shaft 92 to a rear side of the natural woven shade 20c. Each front retaining mechanism 42c may comprise a plurality of ring connectors 94 all coupled to a single shaft 92, with each ring connector 94 transversely spaced apart along the length of the shaft 92. Instead of a single shaft 92, each front retaining mechanism 42c may alternatively comprise a plurality of shorter shafts, with one shorter shaft provided for each ring connector 94.

The coupler 24c is formed with transverse slots 96 to receive the corresponding ring connectors 94 and enable the ring connectors 94 to slide horizontally. This enables the front shade 20c to move horizontally, within a limited scope, with respect to the rear shade 22c which comprises a cellular material.

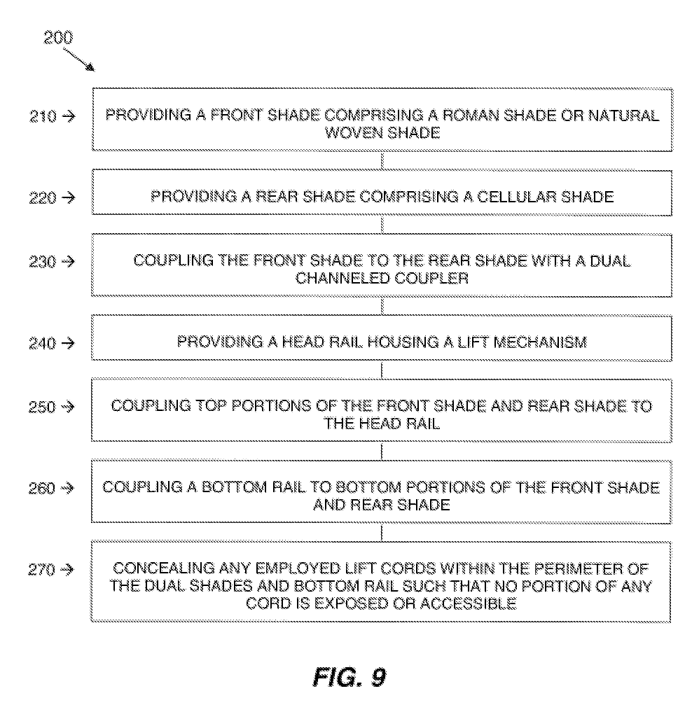

FIG. 9 illustrates a preferred method 200 of making a cordless shade apparatus. The method 200 comprises the step 210 of providing a front shade which may comprise a Roman shade or a natural woven shade. Step 220 comprises providing a rear shade which may comprise a cellular shade. Steps 210 and 220 preferably comprise forming each shade with similar widths such that one shade does not stick out laterally with respect to the other. Steps 210 and 220 also preferably comprise forming both shades with a drawn down, or fully extended, length. Accordingly, steps 210 and 220 are performed so as to form a back-to-back duo of front and rear shades which collectively define an aligned perimeter, within which any employed cords would be disposed and thus hidden from view and access.

In step 230, the front shade is coupled to the rear shade using a dual channeled coupler, or connector. Step 230 comprises disposing a front securing mechanism of the front shade in a front channel of the coupler and disposing a rear securing mechanism in a rear channel of the coupler. Thus, each coupler is connected to a pair of aligned front and rear securing mechanisms.

Where the front shade comprises a natural woven shade, step 230 may comprise disposing a shaft in the front channel of the coupler and attaching a ring connector to the cylindrical shaft and a rear side of the natural woven shade. Slots are formed in the front tube of the coupler to enable the ring connector to attach to the cylindrical shaft located within the front channel.

Step 240 comprises providing a head rail which houses a lift mechanism. The lift mechanism may comprise a cordless lift mechanism.

Step 250 comprises coupling top portions of the front shade and the rear shade to the head rail. The top portions of the front and rear shade may be formed with stiffened materials which can reside in one or more chambers or openings formed in the head rail.

Step 260 comprises coupling a bottom rail to bottom portions of the front and rear shades. Thus, step 260 help define the bottom border of the overall perimeter between the front and rear shades.

Step 270 comprises concealing any employed lift cords within the perimeter of the dual shades and the bottom rail such that no portion of any cord is exposed or accessible. In other words, no portion of any employed cord would be accessible for direct contact or tangling. Step 270 may comprise disposing a lift cord extending from the head rail downward through the coupled front and rear shades to the bottom rail without exposing any portion of the lift cord beyond the perimeter of the dual shades. Thus, step 270 comprises disposing any excess length of the lift cord into the bottom rail.

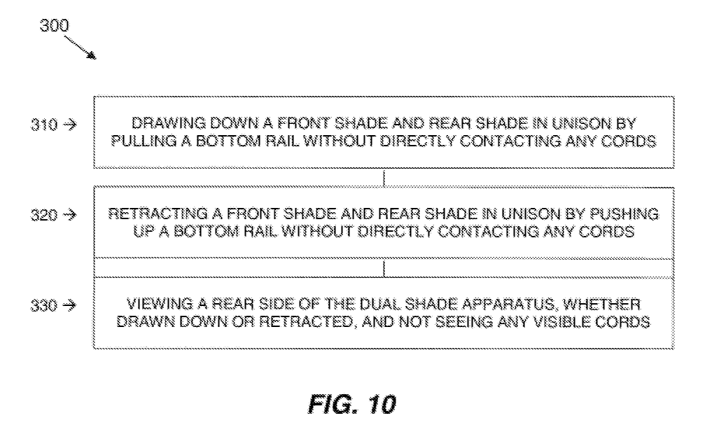

FIG. 10 illustrates a preferred cordless method 300 of operating a dual shade apparatus, namely, manually operating a front and rear shade combination in unison without directly contacting any cords. The method 300 comprises the step 310 of drawing down a front and rear shade in unison by pulling a bottom rail. Step 310 comprises fully extending both the front and rear shade in tandem without directly contacting any cords. Step 310 may comprise drawing down a front Roman shade and a rear cellular shade in unison.

Step 320 comprises retracting the front and rear shade in tandem by pushing up the bottom rail without directly contacting any cords. Step 320 may comprise retracting a front Roman shade and a rear cellular shade in unison.

The method 300 further comprises the step 330 of viewing a rear side of the dual shade apparatus, whether drawn down or retracted, and not seeing any visible cords.

In all the preferred embodiments, it will be appreciated that the rear cellular shade enhances the overall appearance of the shade apparatus by presenting a more aesthetically pleasing interior view than simply looking directly at the rear of a Roman shade. Forming the apparatus with a rear cellular shade also provides an additional benefit of heat insulation.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A safety window shade apparatus, comprising:
a first shade having a first display side, a first inward side and a first retaining mechanism;
a second shade disposed adjacent to the first inward side of the first shade, the second shade comprising a second retaining mechanism;
a coupler coupling the first shade to the second shade, the coupler comprising a first channel configured to receive the first retaining mechanism and a second channel configured to receive the second retaining mechanism;
wherein no portion of a cord is disposed anywhere other than in between the first shade and the second shade.

2. The apparatus of claim 1, wherein the first shade comprises a Roman shade.

3. The apparatus of claim 2, wherein the second shade comprises a cellular shade.

4. The apparatus of claim 1, wherein:
the first channel comprises a first C-channel; and
the second channel comprises a second C-channel.

5. The apparatus of claim 4, wherein:
the second retaining mechanism comprises a cylindrical shaft.

6. The apparatus of claim 1, wherein:
the first shade comprises separate segments;
the first retaining member comprises a pair of separate transverse rigid strips, each strip coupled to a corresponding segment.

7. The apparatus of claim 1, wherein the first shade comprises a natural woven shade.

8. The apparatus of claim 7, wherein the first retaining mechanism comprises:
a shaft configured to be received in the first channel; and
a ring coupled to the shaft and the natural woven shade.

9. The apparatus of claim 1, further comprising:
a head rail; and
a cordless lifting mechanism housed in the head rail and configured to facilitate the lifting and lowering of the first and second shades.

10. The apparatus of claim 1, further comprising:
a bottom rail coupled to a first bottom end of the first fabric and to a second bottom end of the second shade.

11. The apparatus of claim 10, further comprising a lift cord entirely in between the first and second shades, and coupled to the bottom rail.

12. A safety window shade apparatus, comprising:
a first shade comprising a first display side, a first inward side, a first retaining mechanism and a first perimeter;
a second shade disposed adjacent to the first inward side of the first fabric, the second shade comprising a second retaining mechanism and a second perimeter, the first perimeter and the second perimeter being generally aligned to form a collective perimeter;
a double-C coupler comprising a first C-channel configured to receive the first retaining mechanism, and a second C-channel configured to receive the second retaining mechanism; and
a cord disposed entirely between the first shade and the second shade, the cord having no portions exposed beyond the collective perimeter.

13. The apparatus of claim 12, wherein the first shade comprises a Roman shade.

14. The apparatus of claim 13, wherein the second shade comprises a cellular shade.

15. The apparatus of claim 12, wherein:
the first shade comprises separate segments;
the first retaining mechanism comprises a pair of separate transverse rigid strips, each strip coupled to a corresponding segment.

16. The apparatus of claim 12, wherein the first shade comprises a natural woven shade.

17. The apparatus of claim 16, wherein the first retaining mechanism comprises:
a shaft configured to be received in the first channel; and
a ring coupled to the shaft and the natural woven shade.

18. The apparatus of claim 12, further comprising:
a head rail; and
a cordless lifting mechanism housed in the head rail and configured to facilitate the lifting and lowering of the first and second fabrics.

19. The apparatus of claim 12, further comprising:
a bottom rail coupled to a first bottom end of the first fabric and to a second bottom end of the second fabric; wherein
the cord is coupled to the bottom rail.

20. The apparatus of claim 12, wherein the second retaining mechanism comprises a shaft.

21. A method of manufacturing a window shade assembly, comprising:
providing a first shade;
providing a second shade;
coupling the first shade to a dual open-sided coupler;
coupling the second shade to the dual open-sided coupler;
disposing a lift cord entirely in between the first and second shades; and
preventing any portion of the lift cord from being exposed and accessible to physical contact.

22. The method of claim 21, further comprising:
housing a cordless lifting mechanism within a head rail; and
coupling the first shade and the second shade to the head rail.

23. The method of claim 21, wherein coupling the first shade to the dual open-sided coupler comprises disposing in a first channel of the coupler a shaft coupled to the first shade.

24. The method of claim 23, wherein coupling the first shade to the dual open-sided coupler comprises coupling a ring to the shaft and the first shade.

25. The method of claim 21, wherein:
providing the first shade comprises forming fabric segments, each segment having a top retaining strip and a bottom retaining strip;
coupling the first shade to the dual open-sided coupler comprises disposing a top retaining strip and a bottom retaining strip of adjacent segments into a first C-channel of the coupler.

26. The method of claim 21, wherein coupling the second shade to the dual open-sided coupler comprises disposing in a second channel of the coupler a shaft coupled to the second shade.
